(19) United States
(12) Patent Application Publication
(10) Pub. No.: US 2004/0176980 A1
(43) Pub. Date: Sep. 9, 2004

(54) Comprehensive standardized process change management model framework and method for creating customized process model for a healthcare organization using the framework

(76) Inventors: Clemens Bulitta, Spardorf (DE); Dirk Heckermann, Marloffstein (DE); Elaine Kazlauskas, West Chester, PA (US)

Correspondence Address: SCHIFF HARDIN, LLP, PATENT DEPARTMENT, 6600 SEARS TOWER, CHICAGO, IL, 60606-6473, US

(21) Appl. No.: 10/383,945

(22) Filed: Mar. 7, 2003

(51) Int. Cl. G06F 17/60

(52) U.S. Cl. 705/2

(57) ABSTRACT

A healthcare organization/enterprise (HCO) process definition framework is provided that holistically defines processes and process structures for a generic HCO. The HCO framework addresses clinical, operational and financial performance excellence and maximization. This model may be utilized by consultants and HCO representatives working together to integrate the HCO framework into an existing model of a specific HCO to create a customized process model for a this specific HCO. The models may be developed utilizing a process management tool, a best practice and benchmark database and Siemens HCO reference model. The approach focuses, from the beginning, on implementing change, and thus change management is an integral part of the holistic approach.

### BACKGROUND OF THE INVENTION

1. Field of the Invention

The invention relates to the field of healthcare organizations/enterprises (HCOs) and in particular to a comprehensive standardized process change management model (PCMM) framework. The invention also relates to a method for using this framework to provide a customized process model for a particular HCO.

2. Description of the Related Art

A major problem in health care delivery systems is the inefficiency of processes that result in low quality and high cost. The need for quality improvement is described in “Crossing the Quality Chasm: A New Health System for the 21st Century Committee on Quality of Health Care in America”, Institute of Medicine, National Academy Press Washington, D.C., 2001 (“the Institute of Medicine Report”), herein incorporated by reference. This report describes the quality problems in the healthcare industry.

The need for efficient delivery of medical treatment is obvious from all ongoing efforts to achieve operational business improvement within the healthcare market. The current approaches do not use the synergy of applying both efforts (operational and clinical process improvement) in order to reduce cost and improve quality that could create integrated clinical and operational performance excellence, thereby enabling financial performance excellence and maximization. A comprehensive business process framework addressing optimization of clinical, operational, and financial performance has not been applied as the basis for fundamental organizational change in the healthcare industry. The Institute of Medicine Report identifies the need that “the changes needed to realize a substantial improvement in health care involve the health care system as a whole,” but does little to address the concrete mechanisms for accomplishing this.

Current patents and industry offerings generally involve generic process management approaches for generic business environments, focusing heavily on operational performance aspects. Furthermore, when directed to health care environments, current patents and industry offerings typically address improvement needs at the departmental level and not to the level of the entire HCO; current HCO process and business improvement approaches focus only on individual processes or subprocesses, and do not fine-tune a whole system in a comprehensive manner, but rather parts of the system. These partial solutions in health care settings can result in suboptimized process design and metrics identification that may produce a gain in one area but only by introducing a loss in another, e.g., improving the cost of an HCO on one end may worsen performance at the other end. Often the improvement activities focus on operational efficiency and performance without considering the relevant clinical processes, again leading to optimized operational performance only but often producing difficulties and quality problems with care delivery. The prior art has not provided a holistic workable solution to the needs of clinical, operational and financial performance excellence and maximization addressed above.

This non-holistic approach can be illustrated in that, for example, HCOs have historically taken a function-oriented approach to addressing problems. Such a function-oriented view of the HCO involves focusing on perspectives such as the employee being a cause of the problem, attempting to measure individuals and change the person, determining who is at fault when a problem occurs, and controlling employees. Ultimately, these approaches tend to be overly bottom-line driven, and operate in a sub-optimal manner. The functional focus tends to lead to sub-optimal organization and creates functional “silos” such that there are communication gaps between functions, leading to unclear responsibilities of those associated with particular functions. These also tend to result in informal decision making that may not take into consideration other relevant factors or properly address different priorities of functions. Furthermore, whatever metrics are utilized may not be tied to the ultimate success of the HCO, and incentives may not be sufficiently tied to those metrics that are relevant.

Existing relevant prior art patents provide generic methodologies for process improvement and process management. These include: U.S. Pat. No. 6,101,479 directed to a System and Method for Allocating Company Resources to Fulfill Customer Expectations; U.S. Pat. No. 5,467,471 directed to Maintaining Databases by Means of Hierarchical Genealogical table (referenced by the previously mentioned patent); U.S. Pat. No. 6,101,481 directed to a Task Management System; U.S. Pat. No. 6,092,060 directed to Computer-aided Methods and Apparatus for Assessing an Organizational Process or System; U.S. Pat. No. 5,737,494 directed to Assessment Methods and Apparatus for an Organizational Process or System; U.S. Pat. No. 5,930,512 directed to a Method and Apparatus for Building and Running Workflow Process Models using a Hypertext Markup Language; U.S. Pat. No. 6,442,512 directed to an Interactive Process Modeling System; U.S. Pat. No. 6,339,838 directed to a Contol of Commercial Processes; U.S. Pat. No. 5,781,454 directed to a Process Modeling Technique; European Patent Office GB 2370389 directed to a Process for Mapping Change in a Business System; International Patent Application WO 0248935 directed to an Integrated Business Management System; U.S. Patent Publication 2002042731 directed to a Method, System and Tools for Performing Business-related Planning; European Patent EP1 180741 directed to a Flexible System and Method for Standardizing Communications and Decision-making across Multiple Business Processes; and Canadian Patent CA 2337933 directed to a Process Management Graphical User Interface, System and Method.

### SUMMARY OF THE INVENTION

The object of the present invention is to provide a comprehensive standardized process change management model (PCMM) framework (the “HCO framework”) that takes a holistic approach to addressing HCO-related issues, where the framework is generic and independent of any specific HCO, that can be used as a reference model to implement a comprehensive approach to healthcare in dealing with education, sales, research and development and to help provide customer-driven products and services by Siemens Medical Solutions or anyone else associated with the healthcare industry. Another object of the invention is to provide a method for updating and maintaining the HCO framework. A further object of the invention is to provide a method for utilizing this HCO framework to create a customized process model for a particular HCO (the “HCO Customized Model”) by focusing on the specific HCO as a whole and the relationship of the processes within the specific HCO as a whole.

The object of the invention is achieved by a method for creating a customized process model for an HCO using a standardized process change management model comprising pre-defining, by a consultant, a plurality of PCMM patient-centered processes encompassing a plurality of HCO process levels including operations, management and support processes; determining existing processes of an HCO from communications between the consultant and healthcare, management, operations and support personnel at the HCO; identifying, by the consultant and the HCO personnel, a selected group of one or more existing patient processes to re-engineered by the healthcare personnel; and re-engineering the selected group of existing processes with a group of PCMM patient-centered processes. The re-engineering means adapting existing processes and process structures/relationships to conform with the HCO framework.

The object of the invention is also achieved by a comprehensive healthcare organization (HCO) framework, comprising a pre-defined plurality of HCO-related process change management model (PCMM) processes that are independent of a specific HCO, the PCMM processes collectively comprising operations processes, management processes and support processes, the PCMM processes being collectively organized across and identified according to more than one hierarchical level.

The object of the invention is also achived by an HCO framework system comprising the HCO framework combined with an idealized reference model that is based on the HCO framework and that further comprises additional HCO specific information that is based on an idealized HCO.

The object of the invention is also achieved by a method for updating the HCO framework of claim 1, comprising updating the HCO framework based on a new input of information.

The object of the invention is also achieved by a method for utilizing the HCO framework comprising predicting future state processes that may be required by HCOs with the HCO framework.

The HCO framework supports creating health care delivery systems to become patient centered, process focused, and outcome oriented by designing around a common framework with metrics partially based on the Institute of Medicine Report's six specific improvement aims: safety; effectiveness; patient-centeredness; timeliness; efficiency; and equity. Thus this approach generally focuses on improvement of clinical outcomes. The presented unique approach ties this effort into efforts to improve enterprise operations by commonly used efficiency metrics for economic outcomes like, among others, ROI (return on investment) utilization rates, and/or economic value added. This allows for achieving integrated performance optimization, through e.g., defined and reliable measurement and evaluation of performance, comparison of performance states of HCOs and establishment of best practices, thus delivering proven clinical and operational outcome improvements.

Implementing the HCO framework into a specific HCO includes applying the comprehensive methodology, complete processing from the “as is” state to the ideal state or at least some improved state, and utilizing associated metrics to support continuous process improvement to optimize the entire organization. This is done in the context of providing offerings that standardize and optimize the entire system of health care delivery using the pre-defined HCO framework having clinician developed and reviewed content and associated methodologies for comprehensive organizational change (including leadership strategies, process management, and improvement portfolio implementation.) The process model may be designed as an easy to use, web (HTML) based application that enables a navigation through the different process levels. However, other implementations may be considered to be part of the invention as well, including implementations using nothing more sophisticated than paper forms and pencil, standard computer-based applications, etc.

The inventive solutions utilize systems thinking in the field of HCOs in applying a holistic approach focusing on clinical, operational and financial performance excellence and maximization that results in a highly informed decision and are able to: 1) provide an organization-independent framework of processes; 2) adapt this framework of processes to a specific organization; and/or 3) ultimately adapt the framework processes based on feedback from the specific organization implementations.

### DESCRIPTION OF THE DRAWINGS

FIG. 1 is a block diagram providing an overview of the inventive HCO framework and its potential use in the inventive method;

FIG. 2 is a block diagram expanding the HCO framework;

FIG. 3 is a tree diagram illustrating an exemplary hierarchy for the operating processes used for detection;

FIG. 4 is a tree diagram illustrating an exemplary hierarchy for the operating processes used for treatment; and

FIG. 5 is a flowchart illustrating a four-step embodiment of the inventive method.

### DETAILED DESCRIPTION OF THE PREFERRED EMBODIMENTS

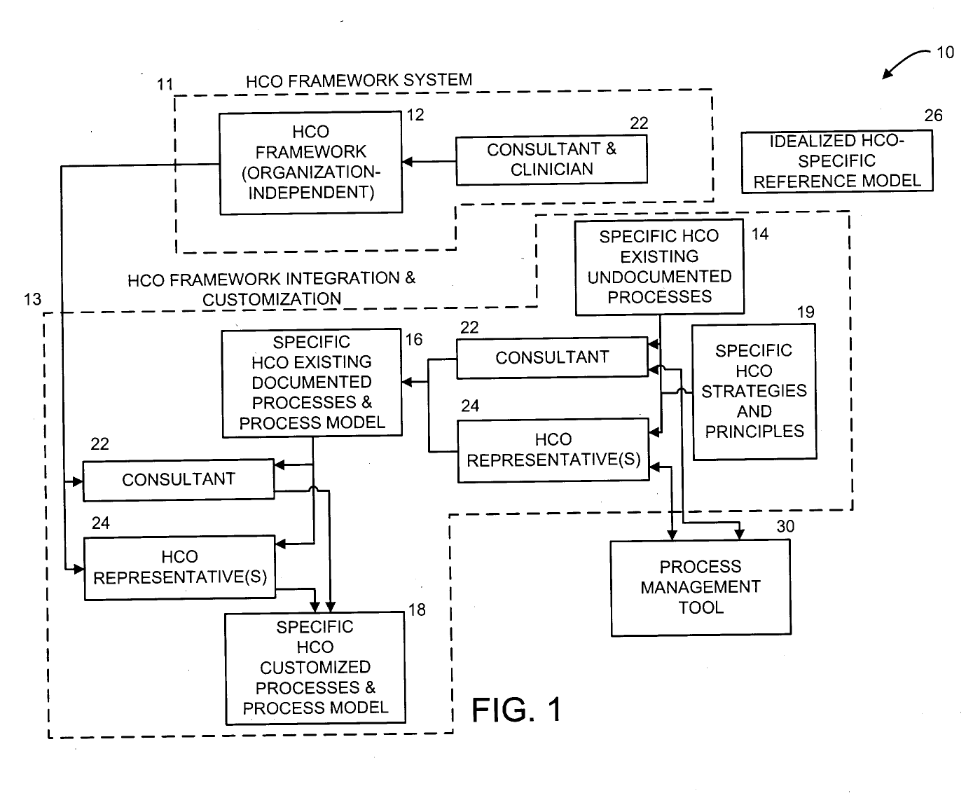

FIG. 1 illustrates the inventive HCO framework and its application to the inventive method for customizing a specific HCO.

There are two broad aspects of the invention: 1) an HCO framework system 11 dealing with the organization, maintenance, and updating of an HCO framework 12, which structures generalized processes independent of a specific HCO; and 2) an HCO framework integration and customization 13, which utilizes the HCO framework 12 and results in an HCO-specific process model 18. The combination of the HCO framework system 11 and the HCO framework integration and customization 13 comprise the overall model for HCO improvement 10.

Although a primary use of the HCO framework system 11 is to provide a standardized model that can be used for HCO framework integration and customization 13 of a particular HCO, the HCO framework system 11 can exist independently of the HCO framework integration and customization 13 and, correspondingly, the HCO framework 12 can exist independently of the specific HCO process models (both the existing processes 16 and the customized processes 18). An independent HCO framework 12 can be used as a reference model to implement a comprehensive approach to healthcare in dealing with education, sales, research and development and to help provide customer-driven products and services by Siemens Medical Solutions or anyone else associated with the healthcare industry, including advisors, experts, partners, etc., apart from a focus on a particular HCO. Thus, the HCO framework 12 is not limited to a structure of defining existing processes, but can also be used to define (and possibly predict) future state processes that may be required by HCOs in response to medical developments, changes in legislation, demographic changes, etc. For example, the discovery of a new medical procedure may impact processes beyond the scope of the medical procedure itself, and this impact may suggest a much broader future state change than the new medical procedure itself might suggest in isolation. Such discoveries are not limited to medical procedures, however, but could include, e.g., discoveries related to communications and data networking, computing, administration, accounting, etc.

In contrast, however, the HCO framework integration and customization 13, according to the invention, requires the use of the HCO framework 12 and thus cannot exist independently in the invention, even though certain processes are HCO specific (and thus, not directly a part of the generalized HCO framework 12).

HCO Framework—the Standardized Process Change Management Model

The HCO framework 12 comprises a hierarchically structured database of process-definitions that may be used both to provide value-added solutions to existing specific HCO customers by adapting their existing processes and organization to conform to the HCO framework 12 model as well as provide a tool for use independently of a specific HCO. The initial HCO framework 12 has been developed based on initial consultations with doctors, nurses, other medical personnel, suppliers, patients, administrators, managers, insurance companies, technology companies, HMOs, etc., and based on years of research and consultation in this field and on literature from the general medical community, from the healthcare industry as a whole and all disciplines affiliated with the industry. This HCO framework 12, however, is not fixed and can be changed over time, based on input from various sources including feedback received during the integration of the HCO framework into a specific HCO (described below), as well as general developments in the field and other newly acquired information. A particularly detailed embodiment of the HCO framework is provided as an example in Appendix B.

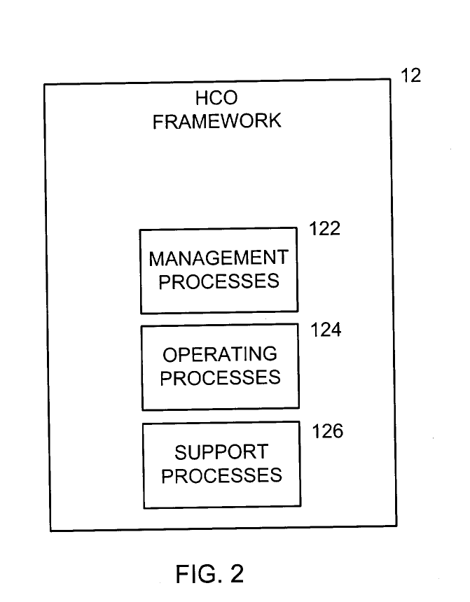

In the HCO framework system 11, an HCO framework 12 is provided that is organization independent, i.e., contains defined processes and hierarchical process structures that are general in nature and do not have the dependencies of any specific organization built in to them. FIG. 2 illustrates a breakdown of the HCO framework 12 that may utilize industry standards and include management processes 122, operating processes 124, and support processes 126, as well as a hierarchical process structure described in more detail below. See also Appendix B, p. 9 for a more detailed view.

This process change management model has been inventively adapted to the field of HCOs by the use of a patient-centric model. In this HCO framework model 12, all work within the operating processes 124 starts with the identification of a patient's needs and ends with the fulfillment of a patient's needs (Appendix B, pp. 2, 9). The management processes 122 and support processes 126, while being somewhat organizationally generic (i.e., not specific to the general field of HCOs), remain a part of the model in that these processes must interface with the highly patient-centric operating processes 124, and thus their application remains part of the inventive system. The very core of the operating processes 124 are those through which care is delivered to the patient. All aspects of this process model are choreographed and continuously optimized to ensure superior clinical and operational outcomes. See Appendix B, p. 35.

The patient-oriented operating processes are focused on the patient at a number of stages. For example, in the planning stages, processes may be provided for understanding a patient and relatives' health policy, pre-clinic negotiations, and providing a care guide for relatives post-clinic help. The patent processes can also include processes, e.g., dealing with pharmaceutical materials, operating (surgery), how to admit, treat, and release the patient, readmittance procedures, dealing with expired materials, and addressing new surgery required or clinical treatment. More detail on potential patient processes is provided in Appendix B, pp. 73-111.

The hierarchical process structure may be used in an embodiment of the invention in which the processes are defined according to some number of hierarchical levels. For example, the number of levels used may be five and be defined in accordance with the Supply Chain Operations Reference Model (SCOR), as discussed in the Overview of SCOR Version 5.0, published by the Supply-Change Council, Inc., 2001, herein incorporated by reference. In this model, the highest level is defined as “Level 0”, and the lowest level is defined as “Level 4” (Appendix B, p. 4). In the SCOR model, these levels are defined in the following manner.

TABLE 1
SCOR Process Hierarchy Levels

| | | |
|---|---|---|
| Level | Process | Process Groups generic- Provides a standardized |
| 0 | Framework | systematic overview of core processes and their |
| | | interactions |
| Level | Top Level | Core Processes generic- Provides definitions |
| 1 | (Process | of the scope and content of the core management, |
| | Types) | operating and support processes |
| Level | Configuration | Process Models, Variants generic- Allows one to |
| 2 | Level | configure and implement individual variants and |
| | (Process | focus strategy |
| | Categories) | |
| Level | Process | Chain with Process Elements - Allows one to |
| 3 | Element | optimize and “fine tune” management, operating |
| | Level | and support processes through the definition of |
| | | process elements, addressing information input |
| | | and output, using performance metrics, tools, |
| | | etc. |
| Level | Implementation | Detailed Process Chain with Processing Elements |
| 4 | Level | generic and specific- Allows one to implement |
| | | specific requirements to achieve optimized |
| | | performance |

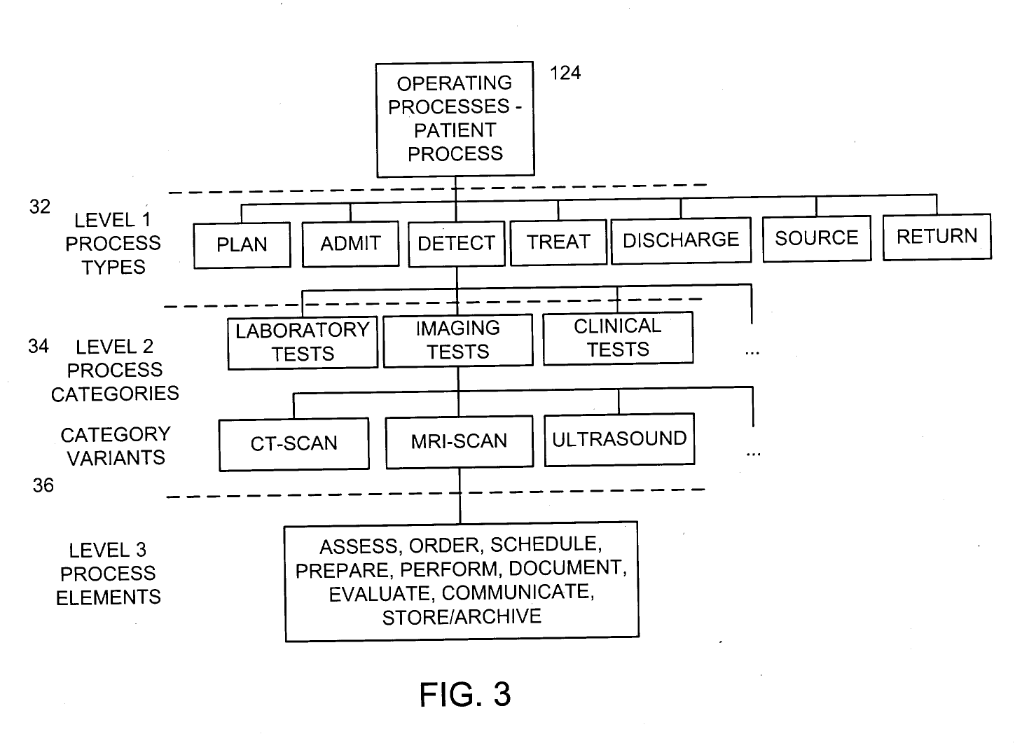

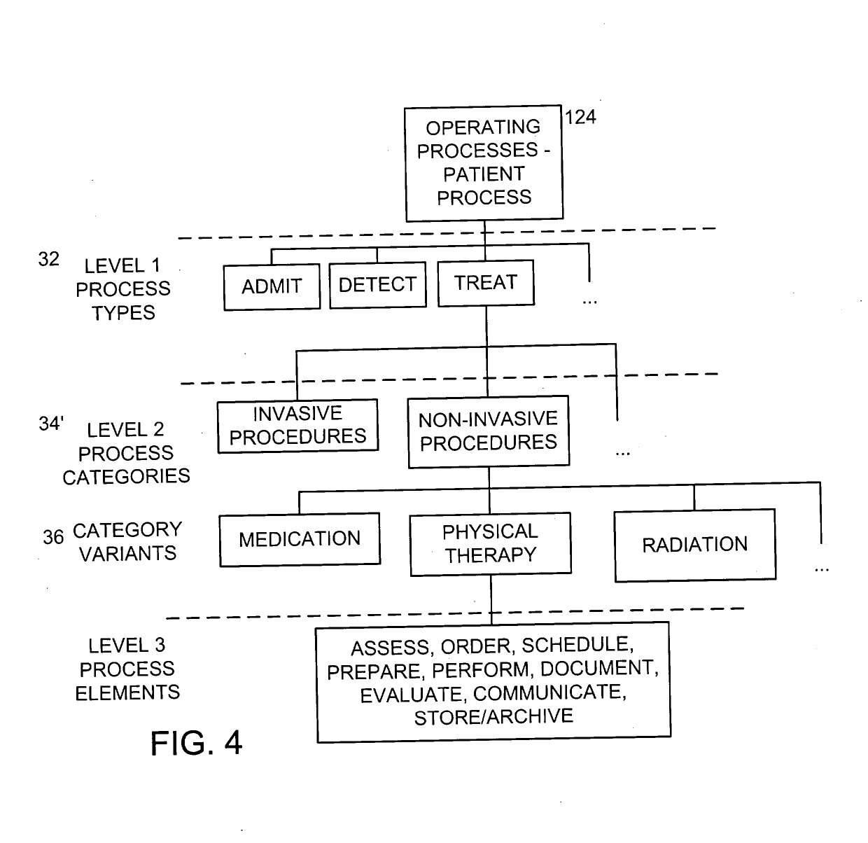

For illustrative purposes, FIG. 3 shows an exemplary organization of the processes according to the operating processes-patient processes 124 (a broader perspective of the patient processes 124 can be seen in Appendix B, pp. 73-111). This exemplary embodiment illustrates a potential hierarchy utilized for the processes. The embodiments shown in FIGS. 3 and 4 are illustrative only and are not intended to provide a comprehensive or complete description of the hierarchy or process at any particular level (see Appendix B, p. 81 and associated description). FIG. 3 shows Level 1 process types 32 that may include plan, admit, detect, treat, discharge, source, and return, e.g. At the Level 2 process categories 34, (focusing in on a particular Level 1 process type) the “detect” process type may include the process categories laboratory tests, imaging tests, and clinical tests, e.g. The imaging tests may, e.g., be subject to three category variants: a CT-Scan, an MRI-Scan and an Ultrasound (see Appendix B, p. 92). The Level 3 process elements 36 might include, for each of the category variants, the following elements: assess, order, schedule, prepare, perform, document, evaluate, communicate, and store/archive.

Similarly, for illustrative purposes and as shown in FIG. 4, the Level 1 process type “treat”, can be broken down into the Level 2 process categories 34′ invasive procedures and non-invasive procedures. The non-invasive procedures may, e.g., address the variants of medication, physical therapy and radiation (see Appendix B, pp. 92, 105 and associated description). This hierarchical organization of the processes helps to ensure that the system can be viewed in a holistic manner. Similar process breakdowns are described in detail in Appendix B. The illustrative examples provided in FIGS. 3 and 4 are not all-inclusive and can accommodate any number of processes at any of the process levels.

This embodiment of the invention may support rule-based process definition to at least these five levels of detail of process decomposition. Details included in the process definition may be documented in the process management tool 30 and may include the following: 1) inputs, outputs, and activities; 2) responsible and participating roles; 3) reference models that support practices of the enterprise; 4) information technology tools that are used to enable the processes and links between the tools and processes; 5) metrics that reflect process performance; and 6) points of integration between processes. An exemplary process definition may be seen in Appendix B at p. 15.

Note that although FIG. 1 only shows access to the process management tool 30 by the consultant 22 and HCO representative 24, it should be understood that the HCO framework 12, HCO existing processes 16, and HCO customized processes 18 may all utilize and/or be implemented with the process management tool 30. Appendix B provides a much more detailed embodiment of the invention for the HCO framework and illustrates a potential hierarchical structure that may be utilized to organize the process definitions.

HCO Framework Integration and Customization of a Specific HCO

As noted above, one of the primary uses of the HCO framework 12 is to be utilized as a tool for creating a customized process model 18 for a particular HCO. This permits use of the HCO framework to provide a unified, structure approach to the customer.

Although use of a process management tool 30 (described below) permits a great deal of customization and detail per customer, it is important that a particular HCO maintains at least the basics of the HCO framework 12. These basics include a structure arranged according to management, operating and support processes, and, within operating processes, maintaining Patient and Partnership Relationship Management (PPRM), Product and Service Lifecycle Management (PSLM) and patient processes as standard. These basics also may include the rules for defining process (use of levels of process decomposition; defining inputs, outputs, activities; roles; references, etc).

This integration of the HCO framework 12 with a particular specific HCO may take place in an embodiment of the invention as follows. The consultant 22 works with a representative of a specific HCO 24 to document existing HCO processes 16. Although the HCO may already have some documented processes, it is usually the case that many of an HCO's existing processes are undocumented or perhaps even non-existent. And it is possible that even the documented processes have significant omissions that would not permit their inclusion in the ultimate resulting customized model 18. Thus, the consultant 22 and HCO representative(s) 24 work together to create documented processes 16 from these undocumented processes 14, preferably based on the model for the individual process previously defined, having 1) inputs, outputs, and activities; 2) responsible and participating roles; 3) reference models that support practices of the enterprise; 4) information technology tools that are used to enable the processes and links between the tools and processes; 5) metrics that reflect process performance; and/or 6) points of integration between processes.

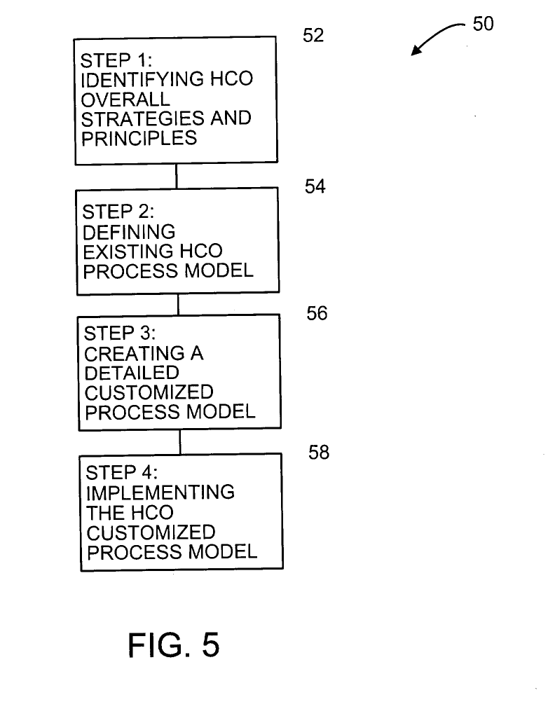

Once the documented processes 16 are created, the consultant 22 and HCO representative(s) 24 work together to determine which existing documented processes 16 (or groups of processes) of the HCO would benefit by utilizing processes within the HCO framework 12. Processes from the HCO framework 12 may be integrated into the existing documented processes 16 for the HCO; one or more of the existing documented processes 16 may be re-engineered or adapted to produce HCO customized processes 18 that fit within a customized model. This integration may be performed according to a four step approach (FIG. 5, 50) presented below.

Step One—Identification of HCO Overall Strategies and Principles 52

According to this embodiment, a consultant 22 works with one or more HCO representatives 24 to identify broad overall strategies and principles of the HCO. The consultant 22 obtains HCO strategies and principles 19 information regarding, for example, organizational identity which encompasses vision (e.g., through an existing vision statement and/or discussions with HCO leadership), mission (e.g., through instruments of incorporation), strategic leadership (e.g., from human resource personnel in the form of goals and objectives of various members in the organization), and environmental analysis (e.g., through consultant 22 or HCO representative 24, through observation, personnel interviews, etc.).

All of this information 19 may be obtained through formal documentation produced by the HCO, through private discussions with key personnel, through meetings of representative employees, through direct observation of procedures, or any other appropriate source. This information is collected and placed in a centrally accessible database. The word “database” here is used in a general sense and although it is preferably in an electronic format, the database could be nothing more than an index of paper cards. In an embodiment of the invention, this information may be placed in a web-based process management tool 30 (described below). This step includes mapping out the requirements for change in the HCO.

Step Two—Definition of Existing HCO Process Model 54

Once the overall strategies and principles 19 of the HCO have been obtained and stored in a database, the consultant 22 works with the representative 24 of the HCO and begins identifying and defining an existing process model 16 for the HCO. This includes using business process management in which process owners are identified for at least each major process or group of processes. Process owners may be identified by a governance level that could include: 1) collective—process owners are groups of departments or groups of individuals; 2) single—process owners are single departments; and 3) individual—process owners are single individuals. A process owner is responsible for the detailed definition, implementation and optimization of a process. Training may be provided to process owners in aspects of process management during this step.

There are two significant aspects that may be used during the identifying and defining stage of the existing process to produce the HCO existing processes 16. The first is the use of a business process-management methodology (described below) to improve performance measured through relevant business metrics. The second includes the use of a process model adapted for HCOs as the starting point for analyzing the current state of the HCOs' processes, mapping requirements for change (identified during the previous Step One) to the current situation, comparing these to the HCO framework 12, and then, in Step Three defining the customized process model 18 for a particular HCO. This information may then be placed in the web-based information management tool 30, described below in relationship to the process management tool 30.

Step Three—Creating a Detailed Customized Process Model 56

In Step Three, the consultant 22 works with the HCO representative 24 to create a detailed process model for the HCO 18. During this Step, process metrics are defined that address the customized process model as a whole. These metrics could, for example, be broken down into the broad classifications previously identified: 1) enterprise management, 2) operating processes, and 3) business administration and support. Refer to Appendix A for the identification of metrics that can be considered in the context of the HCO. The metrics in Appendix A reflect a combination of those metrics already known as well as those determined based on extensive consulting experience—Appendix A reflects an inventive combination and holistic view to these metrics.

The detailed process model goes through a level of validation by comparing it with a Siemens HCO Reference Model (SHCORM) 26. The SHCORM is an idealized reference model 26 that is similar to an HCO customized process model 18 in that it is based on the HCO framework 12, but includes additional information that may be HCO specific. However, the HCO specific information relates to a “virtual” or “idealized” HCO that implements the best practice processes in all process levels. The SHCORM 26 comprises a database of worldwide evidence-based medicine guidelines, care paths and best-practice healthcare enterprise processes (qualitative and quantitative data). The SHCORM 26 may be used to identify the gap of the particular HCO that is being assessed with the HCO to a “virtual” worldwide best practice healthcare enterprise. The SHCORM 26 is dynamic as it is the nature of evidence-based medicine and will be permanently developed further based on the information from the worldwide consulting projects and HCO process assessments with the HCO process model. The SHCORM 26 enhances the system-based and holistic approach of utilizing a common language and structure approach to dealing with healthcare industry-related issues.

Step Four—Implementation of the HCO Customized Process Model 58

Once the HCO customized process model and processes 18 are defined, implementation and optimization steps of the business process management methodology are performed, creating an implementation strategy.

In a preferred embodiment, this implementation strategy may address: 1) pilot testing new processes in the organization, i.e., training a limited number of medical care provider, administrative, management personnel, and other relevant participants on the use of the new processes, monitoring the quality of each process, and making any changes necessary before cross-enterprise use of the process occurs; 2) training employees based on the roles they will play in the new process; 3) scheduling mass deployment (e.g., which departments will adopt the new processes and by when); and 4) monitoring the process metrics that have been defined as part of Step Three.

The process model that is implemented may be provided in the process management tool 30. The newly implemented processes may be allowed to stabilize for some period of time (this time period being dependent on the complexity and nature of the process). Once some level of stability is achieved, the owners of the processes may begin optimization (continuous improvement) activities. The implemented model 18 becomes the basis for all future process improvement, benchmarking, and knowledge sharing for the specific HCO. The HCO's ultimate process model then represents a combination of: 1) the best practices delivered in the original version of the HCO framework 12; 2) the value-added content; and 3) organization-specific content.

The relationship between the consultant 22 and the HCO representatives 24 need not end at this stage; rather it can continue on as long as the relationship is mutually beneficial. For example, it may be possible for the consultant 22 to implement some of the value-added content noted above that is independent of the HCO into the HCO framework 12. Although a specific HCO might initially not want such value-added content to be included in the HCO framework (as it might permit other competing HCOs to benefit), this specific HCO might also be able to benefit from value-added content from another HCO—thus, the inclusion of a specific HCO's value-added content by the consultant 22 into the HCO framework 12 could be viewed as a beneficial exchange by this HCO for their use of other HCOs' value-added content. Additionally, going the other way, it may be possible over time that the HCO framework 12 has evolved additional beneficial processes that could be again integrated into the HCO customized model 18.

Process Management Tool

The process management tool 30 may serve as a centralized data repository that may be used in an embodiment of the invention for the input, processing, and output of all process-related material, including the HCO framework 12 and the processes defined within, as well as the HCO existing documented processes 16 and the HCO customized process model and processes 18. In a preferred embodiment, the process management tool 30 utilizes a web-based user input and output and communications architecture, but it is not limited to this approach.

The process management tool 30 may be implemented according to the following rule-based definitions: 1) processes can be decomposed to at least five levels; 2) process definitions include a description of inputs (including its source), outputs (including its target), and activities associated with the process; 3) interfaces between processes are identified; 4) metrics are defined for monitoring the effectiveness and quality of processes; 5) reference models on which processes are based are identified and linked to the process (i.e., the original reference model and documentation could remain available and accessible along with the customized model); and 6) information technology tools that enable the process are identified and linked to the process activity they support.

Also, standards, rules and recommendations may be provided, as well as the previously described governance level. The process descriptions may be provided on a process description card and the descriptions on such cards may be provided as input or output to/from the web-based tool. The advantage of utilizing these rule-based definitions is that a process template contained within the process management tool 30 may be used to provide rapid process documentation. Users can learn how to document a process quickly, as the structure of processes are pre-defined and many allowable values for the required fields for documenting a process are contained in e.g., drop-down lists.

Furthermore, the process management tool 30 may be configured to provide intelligent reporting capabilities that allow users to troubleshoot process definitions. For example, if there is an input without a source or an output without a target, the tool can produce a report to support this and also suggest potential corrections.

The primary use for the process management tool 30 is during each of the four steps of the HCO framework integration 13; however, this tool could also be used to maintain and update the HCO framework 12 itself. Furthermore, HCO representatives 24 can assume ownership and support of the process management tool 30 after qualification training.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The present invention may be described in terms of functional block components and various processing steps. Such functional blocks may be realized by any number of hardware and/or software components configured to perform the specified functions. For example, the present invention may employ various processing elements, logic elements, look-up tables, and the like, which may carry out a variety of functions under the control of one or more computer systems that may be networked together in some fashion. Similarly, where the elements of the present invention are implemented using software programming or software elements the invention may be implemented with any programming or scripting language such as C, C++, Java, assembler, or the like, with the various algorithms being implemented with any combination of data structures, objects, processes, routines or other programming elements. Furthermore, the present invention could employ any number of conventional techniques for user input, data processing and the like.

The particular implementations shown and described herein are illustrative examples of the invention and are not intended to otherwise limit the scope of the invention in any way. For the sake of brevity, conventional software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

### Appendix A

### Possible Metrics

Under enterprise management, metrics related to financial performance, outcomes and satisfaction could be considered. These metrics could include, among others:

TABLE 1

number of workshops for improvement
of politics and strategy
management dedicated time for quality projects
number of patients according to health insurance
length of stay extension
sales per fte
cash flow per fte
contribution margin per fte
equity rate
profit per fte
cash flow rate
return on capital
return on equity
return on sales
operative profit
contribution margin per drg
case mix index
internal drg base rate
operative revenue
growth rate
cases p.a.
no. of performed services
length of stay
patient census
unit profitability
funds raised for facility improvements
average length of stay
length of stay
sales volume
return on investment
operative profit
asset turnover
return on sales
return on equity
economic value added
shareholder value
profit per fte
market share

Under operating processes, metrics could be classified under Patient-Partner Relationship Management, Product/Service Lifecycle Management, and Patient Processes.

The Patient Partner Relationship Management metrics could include:

TABLE 2

Safety
Patient-Centeredness
Number of Workshops with referring Physicians
Referring Physicians Satisfaction
Patient Satisfaction
Communication with Referring Physicians
Patient Satisfaction
Patient Referral Rate
Reclamations
Recommendation Rate
Effectiveness
Timeliness
Reclamation Rate
Recommendation Rate
Referring Physicians Satisfaction
Satisfaction of health insurances
Patient Retention
Timeliness Discharge Letter
Patient Satisfaction
Reclamation Rate

The Product Service Lifecycle Management metrics could include:

TABLE 3

Efficiency
Number of Clinical Pathways
Rate of Improvement Suggestions
Growth Rate
Competencies
Training Hours per caregiver
Equity
Sales Contribution of new Services
Rate of successful implemented Improvement suggestions
Knowledge about needs of stakeholders
Improvement suggestions

The Patient Process metrics could include:

TABLE 4

For Acute Myocardial Infarction
Aspirin at Arrival
Aspirin at discharge
Beta Blocker at arrival
Beta blocker at discharge
ACE inhibitor for left ventricular systolic dysfunction
For Heart Failure
left ventrincular function assessment
ACE inhibitor for left ventricular systolic dysfunction
For Pneumonia
Initial antibiotic timing
Pneumococcal vaccination
Oxygenation assessment

The Patient Processes could also be broken down according to classifications of care indicators, that may include:

TABLE 5

Inpatient Acute Care indicators
Device-Associated Infections in Intensive Care Units
Surgical Site Infections
Prophylaxis for Surgical Procedures
Neonatal Mortality
Management of Labor
Unscheduled Admissions Following Ambulatory Procedures
Unscheduled Returns to the Operating Room
Isolated CABG Perioperative Mortality
Documented Falls
Pressure Ulcers in Acute Care
Device Use in Intensive Care Units
Inpatient Mortality
Perioperative Mortality
Unscheduled Readmissions
Unscheduled Returns to Intensive Care Units
Physical Restraint Events
Complications following Sedation
and Analgesia in Intensive Care Units(14a),
Cardiac Catheterization Labs(14b),
Endoscopy Suites(14c),
Emergency Departments(14d),
and Radiology Suites(14e)
Ambulatory Care Indicators
Unscheduled Returns to the Emergency Department
X-Ray Study Discrepancies in the Emergency Department
Requiring a Change in Patient Management
Cancellation of Scheduled Ambulatory Procedures
Length of Stay in the Emergency Department
Patients Leaving the Emergency Department Before
Completion of Treatment
Psychiatric Care Indicators
Injurious Behaviors
Transfers to Inpatient Acute Care
Physical Restraint Events
Partial Hospitalization Programs
Unplanned Departures Resulting in Discharge
Readmissions to Inpatient Psychiatric Care
Seclusion Events
Medication Use (PILOT)
Long Term Care Indicators
Unplanned Weight Gain
Documented Falls
Nosocomial Infections
Pressure Ulcers
Unscheduled Transfers/Discharges to Inpatient
Acute Care
Physical Restraint Events
Home Care Indicators
Unscheduled Transfers to Inpatient Acute Care
Discharge to Nursing Home Care
Use of Emergent Care Services
Acquired Infections

Additional patient process metrics could include:

TABLE 6

Waiting Times Emergency Room
Waiting times Radiology
Rate of postponed admissions to elected surgery
Rate of postponed elected Surgeries
Mortality
Rate of Transfusion incidents
Rate of Patients with multiresistent germs
Postoperative Infections
Unsceduled Re-entries
Team Quality
Management of errors
Rate of Emergency Patient Readmission
Rate of Hospital acquired Infections
Outpatient Waiting times
Tracer Inginual Hernia
Tracer Acute Myocardial Infarction
Tracer Diabetes Mellitus
Tracer Breast Cancer
Tracer Total endoprosthesis for Primary Cox Arthrosis
Unscheduled Rehospitalization
Documented Falls, Injuries
Waiting Times Emergency
Anaesthesiological complications
Pressure Ulcers
Patient Mortality, e.g., 10-day Mortality
Heart Module
Resource utilization
Process Times
Process error rates
Waiting Times Functional diagnostics
Rate of discarded Blood Products
Rate of Patients with high preoperative length of stay
Neonatal Mortality
Unscheduled Readmissions
Readmissions to OR
Nosocomial Infections
OR Utilization
Waiting times for elected OP
Standardization of Processes
Patient Loads
Rate of unplanned Return to OR
Waiting times for elective surgery
Tracer Appendicitis and
Suspected Appendicitis
Tracer Proximal Femoral Fracture
Tracer Cerebrovascular Insultt
Tracer Birth by Cesarian Section
Tracer Benign Prostatic Hyperplasia
Tracer Cataract
Unscheduled Re-Intervention
Waiting Times elected Surgery
Suspension of elective Surgery
Nosocomial Infections
Improvement of individually felt health status
Discharges, e.g., to home, nursing home, rehabilitation
Lung Module
Waiting times
Productivity per fte.

Note that “tracer” in Table 6 means exemplary representative Diagnosis/Pathway including metrics, which could serve as a template for other Diagnosis/Pathways.

Finally, under business administration and support, metrics could be classified according to cost/revenue, productivity, and resource utilization.

These metrics could include:

TABLE 7

Training Budget
Staff cost
Effectivity of Personnel Management
Work Overtime
Average Job Tenure
Asset depreciation
Liquidity
Employee Satisfaction
Condition of Capital
Cost per Non-inpatient Occassion of Service
User cost of capital per separation
Liquid assets
Liquidity
Fixed cost
Case Mix Index
Staff efficiency
Staff qualification index
Staff development
Material Cost
Staff Satisfaction
Fluctuation Rate
Capital intensity per Case Mix adjusted treatment
Overhead Cost
Employee Satisfaction
Employee Turnover Rate
Cost of Casemix adjusted separation
Labor Cost per separation
Capital assets
Accounts receivable
Variable costs
Cost of Nonconformance
PCCL
Staff effectiveness

Under people, metrics could include (note: fte means full time equivalent and is equated to one person working, for example, 1280 hours per year):

TABLE 8

cost/revenue per full time equivalent
education budget per fte
staff retention
cases per fte
safety regulation compliance
a staff satisfaction score

Under resources (that might include materials, equipment, it, and facilities), metrics might include:

TABLE 9

procurement cost per case
disposal cost per case
services cost per case
materials and logistics cost per case
maintenance cost per resource

What is claimed is:

1. A comprehensive healthcare organization (HCO) framework, comprising:
a pre-defined plurality of HCO-related process change management model (PCMM) processes that are independent of a specific HCO, the PCMM processes collectively comprising operations processes, management processes and support processes, the PCMM processes being collectively organized across and identified according to more than one hierarchical level.

2. The HCO framework according to claim 1, wherein the PCMM processes each comprise data structures relating to:
inputs, outputs, and activities;
responsible and participating roles;
reference models that support practices of an enterprise;
information technology tools that are used to enable processes and links between the tools and the processes;
metrics that reflect process performance; and
points of integration between processes.

3. The HCO framework according to claim 1, wherein the more than one hierarchical level comprises:
a level 1 process level comprising processes of the operations processes, the management processes and the support processes;
a level 2 process category level comprising processes of the operations processes, the management processes and the support processes; and
a level 3 process element category comprising processes of the operations processes, the management processes and the support processes.

4. The HCO framework according to claim 3, wherein:
the level 1 management processes comprise a manage enterprise strategically process, a manage quality process, and a control strategically process;
the level 1 operations processes comprise:
under a patient-partner relationship management category, a plan process, an understand customer markets process, a sell process, and a care process;
under a product-service lifecycle management category, a plan process, a manage product portfolio process, a define process, a realize process, a commercialize process, and a phase-out process; and
under a patient process category, a plan process, an admit process, a detect process, a treat process, a discharge process, a source process, and a return process; and
the level 1 support processes comprise:
under a finance and controlling category, a manage finance process and a control process;
under a people category, a manage human resources process, an educate process, a manage knowledge process, and a manage environmental health and safety process; and
under a resources category, a manage materials and logistics process, a maintain equipment and facilities process, a manage information and communication process, and a provide services process.

5. The HCO framework according to claim 4, wherein each of the level 1 processes has one or more level 3 processes associated with it.

6. The HCO framework according to claim 1, further comprising:
a process management tool configured to accept process-related information and update the HCO framework with the process-related information.

7. The HCO framework according to claim 6, wherein the process management tool is a web-based tool.

8. An HCO framework system comprising:
the HCO framework according to claim 1; and
an idealized reference model that is based on the HCO framework and that further comprises additional HCO specific information that is based on an idealized HCO.

9. The HCO framework system according to claim 8, wherein the idealized reference model further comprises a database of worldwide evidence-based medicine guidelines, care paths and best-practice healthcare enterprise processes that comprises qualitative and quantitative data.

10. A method for updating the HCO framework of claim 1, comprising:
updating the HCO framework based on a new input of information.

11. The method for updating the HCO framework according to claim 10, wherein the input of new information is obtained by consulting with at least one of doctors, nurses, other medical personnel, suppliers, patients, administrators and managers about at least one of processes and process structure.

12. The method for updating the HCO framework according to claim 10, wherein the input of new information is obtained by reviewing literature from a field selected from the group consisting of the healthcare industry, technology, science, and administration and management.

13. The method for updating the HCO framework according to claim 10, wherein the input of new information is obtained by activities associated with implementing an HCO framework integration and customization of a specific HCO.

14. The method for updating the HCO framework according to claim 10, wherein the updating is performed iteratively.

15. A method for utilizing the HCO framework of claim 1, comprising:
predicting future state processes that may be required by HCOs with the HCO framework.

16. A method for creating a customized process model for a specific healthcare organization (HCO), comprising:
a) pre-defining, by a consultant, a comprehensive HCO framework comprising a plurality of PCMM HCO-independent processes encompassing a plurality of healthcare organization process levels including operations processes, management processes and support processes;
b) identifying the specific HCO overall strategies and principles;
c) defining existing processes of an HCO from communications between the consultant and healthcare representatives;
d) identifying, by the consultant and the healthcare representatives, a selected group of one or more of the existing processes to be re-engineered;
e) re-engineering the selected group of existing processes using a group of PCMM processes from the HCO framework, thus creating a specific HCO customized process model and processes; and
f) implementing the HCO customized process model and processes at the HCO.

17. The method according to claim 16, further comprising:
providing an idealized HCO reference model that is based on the HCO framework and that further comprises additional HCO specific information based on an idealized HCO; and
validating the HCO customized process model and processes by comparing it with the idealized HCO reference model and implementing any changes suggested by the validation.

18. The method according to claim 17, further comprising:
updating the idealized HCO reference model with new qualitative and quantitative data obtained from at least one of worldwide evidence-based medicine guidelines, care paths and best-practice healthcare enterprise processes.

19. The method according to claim 16, wherein the elements of determining, providing, and re-engineering are performed iteratively with the consultant and the healthcare representative.

20. The method according to claim 16, further comprising:
providing a process management tool;
inputting one or more of the plurality of PCMM HCO-independent processes of the HCO framework into the process management tool; and
modifying one or more of the plurality of processes of the HCO framework by the re-engineered processes to create the specific HCO customized process model and processes.

21. The method according to claim 20, further comprising:
providing a web-based interface and database management system for operating the process management tool.

22. The method according to claim 20, wherein modifying the one or more plurality of processes of the HCO framework comprises utilizing pre-defined process structures for rapid user definition.

23. The method according to claim 22, wherein the pre-defined process structures include data relating to one or more of: 1) inputs, outputs, and activities; 2) responsible and participating roles; 3) reference models that support practices of an enterprise; 4) information technology tools that are used to enable the processes and links between the tools and processes; 5) metrics that reflect process performance; and 6) points of integration between processes.

24. The method according to claim 16, further comprising:
providing metrics for the plurality of processes of the HCO framework.

25. The method according to claim 24, further comprising:
providing metrics categorized as enterprise management metrics, operating process metrics, and business administration and support metrics.

26. The method according to claim 25, further comprising:
providing, for the enterprise management metrics, metrics related to at least one of market share outcomes, satisfaction, mortality or morbidity score, length of stay, patient retention, and financial performance;
providing, for the operating processes metrics, metrics related to at least one of safety, effectiveness, patient-centeredness, timeliness, efficiency, equity, the metrics also including measures of utilization per resource, adverse events per case, cost/revenue per case, waiting time per test/procedure, cycle time per test/procedure, and patient/referring physician satisfaction score; and
providing, for business administration and support metrics, metrics related to at least one of cost and revenue productivity and resource utilization, cost to collect, percent of claim denials, cash received as a percent of gross revenue, fixed assets as a percent of gross revenue, administrative cost per discharge, cost and revenue per fte, cases per fte, education budget per fte, safety regulation compliance, staff retention and a staff satisfaction score, procurement cost per case, materials and logistics cost per case, disposal cost per case, maintenance cost per resource, and services cost per case.

27. The method according to claim 16, wherein implementing the HCO customized process model comprises at least one of:
pilot testing a new process in the HCO, comprising:
training a limited number of personnel use the new process;
monitoring a quality of each process;
making necessary changes to the process prior to cross-enterprise use;
training employees based on roles they will play in the new process;
scheduling mass deployment by providing which departments will adopt the new process and by when; and
monitoring process metrics.

28. The method according to claim 16, further comprising:
allowing a newly implemented process to stabilize for some period of time, the period of time being dependent on a complexity and nature of the newly implemented process;
once stabilization is achieved, optimizing the newly implemented processes by process owners.
